(19) United States
(12) Patent Application Publication
(10) Pub. No.: US 2023/0260338 A1
(43) Pub. Date: Aug. 17, 2023

(54) DETERIORATION DIAGNOSIS SYSTEM, DETERIORATION DIAGNOSIS DEVICE, DETERIORATION DIAGNOSIS METHOD, AND RECORDING MEDIUM

(71) Applicant: NEC Corporation, Minato-ku, Tokyo (JP)

(72) Inventors: Nana Jumonji, Tokyo (JP); Chisato Sugawara, Tokyo (JP); Yosuke Kimura, Tokyo (JP); Maiko Hasegawa, Tokyo (JP)

(73) Assignee: NEC Corporation, Minato-ku, Tokyo (JP)

(21) Appl. No.: 18/014,255

(22) PCT Filed: Jul. 6, 2020
(86) PCT No.: PCT/JP2020/026431

§ 371 Date: Jan. 3, 2023

(51) Int. Cl. G07C 5/08; G07C 5/00

(52) U.S. Cl. CPC G07C 5/0808; G07C 5/008; G07C 5/085

(57) ABSTRACT

The present invention associates a deterioration detected on the basis of sensor information gathered by a mobile object with a correct confirmation result obtained at the site where the deterioration has occurred. This deterioration diagnosis device 1 has a diagnosis unit 2 that provides a diagnosis of deterioration of a road surface by analyzing sensor information gathered by a mobile object and then outputs the location of detected deterioration. An association unit 3 associates a diagnosis result with the confirmation result on the basis of the location of a road surface deterioration confirmed by humans and the location of the deterioration detected from the diagnosis. A storage unit 4 stores therein the diagnosis result and the confirmation result thus associated.

### TECHNICAL FIELD

The present disclosure relates to a deterioration diagnosis system, a deterioration diagnosis device, a deterioration diagnosis method, and a recording medium.

### BACKGROUND ART

In the inspection of a road, a deterioration diagnosis system that detects road deterioration by analyzing a road image captured from a vehicle by a computer has been introduced.

As an example of such a deterioration diagnosis system, for example, PTL 1 discloses a pavement information collection and inspection system that collects a road image captured by a vehicle, detects road deterioration, and causes a terminal to display information related to deterioration or the like from a point on a map in a referable manner. In addition, PTL 2 discloses a defect analysis system that associates a road surface defect detected by analysis of road surface image information with a position of the road surface defect and indicates the result on a map.

### CITATION LIST

### Patent Literature

[PTL 1] JP 2019-196680 A

[PTL 2] JP 2018-017102 A

### SUMMARY OF INVENTION

### Technical Problem

In a case where road deterioration is managed using a deterioration diagnosis system as described in PTL 1 or PTL 2, a road administrator or the like is required to go to a place (site) where deterioration actually occurs and directly confirm deterioration by visual observation or the like in order to check a detailed state of deterioration. In this case, the road administrator or the like goes to the site to confirm the deterioration with reference to the deterioration state and the detection position output from the deterioration diagnosis system, but may confirm deterioration different from the deterioration output from the deterioration diagnosis system. Therefore, there is a possibility that an erroneous confirmation result is associated with the deterioration detected by the deterioration diagnosis system.

An object of the present disclosure is to solve the above-described problems and to provide a deterioration diagnosis system, a deterioration diagnosis device, a deterioration diagnosis method, and a recording medium capable of associating a correct confirmation result at an occurrence place with deterioration detected based on sensor information collected by a moving object.

### Solution to Problem

A deterioration diagnosis device according to an aspect of the present disclosure includes a diagnosis means configured to diagnose deterioration on a road by analyzing sensor information collected by a moving object to output a position of a detected deterioration, an association means configured to associate, based on a position of deterioration on a road confirmed by a person and a position of deterioration detected by the diagnosis, a result of the diagnosis with a result of the confirmation, and a storage means configured to store the result of the diagnosis and the result of the confirmation associated with each other.

A deterioration diagnosis system according to an aspect of the present disclosure includes the deterioration diagnosis device according to an aspect of the present disclosure, and a terminal device that receives an input of a result of the confirmation to transmit the result of the confirmation to the deterioration diagnosis device.

A deterioration diagnosis method according to an aspect of the present disclosure includes diagnosing deterioration on a road by analyzing sensor information collected by a moving object, outputting a position of a detected deterioration, associating, based on a position of deterioration on a road confirmed by a person and a position of deterioration detected by the diagnosis, a result of the diagnosis with a result of the confirmation, and storing the result of the diagnosis and the result of the confirmation associated with each other.

A recording medium according to an aspect of the present disclosure records a program causing a computer to execute diagnosing deterioration on a road by analyzing sensor information collected by a moving object, outputting a position of a detected deterioration, associating, based on a position of deterioration on a road confirmed by a person and a position of deterioration detected by the diagnosis, a result of the diagnosis with a result of the confirmation, and storing the result of the diagnosis and the result of the confirmation associated with each other.

### Advantageous Effects of Invention

An effect of the present disclosure is that a correct confirmation result at an occurrence place can be associated with deterioration detected based on sensor information collected by a moving object.

### BRIEF DESCRIPTION OF DRAWINGS

FIG. 1 is a diagram showing a configuration of a deterioration diagnosis system 10 in the first example embodiment.

FIG. 2 is a diagram illustrating an example of a diagnosis result in the first example embodiment.

FIG. 3 is a diagram illustrating an example of a confirmation result in the first example embodiment.

FIG. 4 is a block diagram illustrating a configuration of a deterioration diagnosis device 20 and a terminal device 50 according to the first example embodiment.

FIG. 5 is a diagram illustrating an example of deterioration information in the first example embodiment.

FIG. 6 is a flowchart illustrating an overall operation of the deterioration diagnosis system 10 in the first example embodiment.

FIG. 7 is a flowchart illustrating details of a diagnosis process (step S11) in the first example embodiment.

FIG. 8 is a diagram showing another example of deterioration information in the first example embodiment.

FIG. 9 is a diagram illustrating an example of a deterioration position map screen of the deterioration diagnosis device 20 in the first example embodiment.

FIG. 10 is a diagram illustrating an example of a deterioration information screen according to the first example embodiment.

FIG. 11 is a diagram illustrating an example of a deterioration position map screen of a terminal device 50 in the first example embodiment.

FIG. 12 is a flowchart illustrating details of a route guidance process (step S17) in the first example embodiment.

FIG. 13 is a view illustrating an example of a route guidance screen in the first example embodiment.

FIG. 14 is a view illustrating an example of a deterioration position guide screen in the first example embodiment.

FIG. 15 is a diagram illustrating an example of a confirmation result input screen according to the first example embodiment.

FIG. 16 is a flowchart illustrating details of an association process (step S21) according to the first example embodiment.

FIG. 17 is a diagram illustrating another example of a deterioration position map screen of the deterioration diagnosis device 20 according to the first example embodiment.

FIG. 18 is a diagram illustrating another example of a deterioration information screen according to the first example embodiment.

FIG. 19 is a view illustrating a definition example of a display mode of deterioration on a deterioration position map screen in the first example embodiment.

FIG. 20 is a diagram showing still another example of deterioration information in the first example embodiment.

FIG. 21 is a view illustrating still another example of the deterioration position map screen in the first example embodiment.

FIG. 22 is a diagram illustrating an example of transition of a display mode of deterioration in the first example embodiment.

FIG. 23 is a diagram showing another example of transition of a display mode of deterioration in the first example embodiment.

FIG. 24 is a diagram illustrating an example of a diagnosis result selection screen according to the second example embodiment.

FIG. 25 is a block diagram showing a configuration of a deterioration diagnosis device 1 in a third example embodiment.

FIG. 26 is a block diagram illustrating an example of a hardware configuration of a computer 500.

### EXAMPLE EMBODIMENT

Each example embodiment will be described in detail with reference to the drawings. In the respective drawings and the respective example embodiments described in the specification, the same reference numerals are given to the same components, and the description thereof will be omitted as appropriate.

(First Example Embodiment)

The first example embodiment will be described.

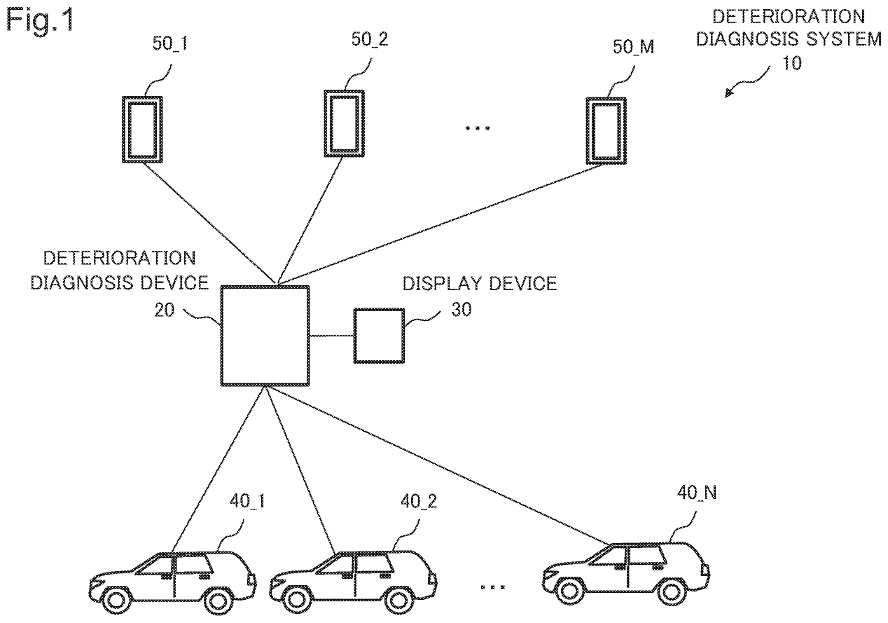

First, an overall configuration of a deterioration diagnosis system according to a first example embodiment will be described. FIG. 1 is a diagram illustrating a configuration of a deterioration diagnosis system 10 according to the first example embodiment. Referring to FIG. 1, the deterioration diagnosis system 10 includes a deterioration diagnosis device 20, a display device 30, a plurality of vehicles 40_1, 40_2, . . . , 40_N (N is a natural number) (hereinafter, collectively referred to as a vehicle 40), and terminal devices 50_1, 50_2, . . . , 50_M (M is a natural number) (hereinafter, collectively referred to as a terminal device 50).

The deterioration diagnosis device 20 and the vehicle 40 are connected via a communication network or the like. The deterioration diagnosis device 20 and the terminal device 50 are also connected via a communication network or the like.

The vehicle 40 belongs to a road management organization such as a local government or a road management company. The vehicle 40 captures a road image by an image sensor such as a camera of a drive recorder, and transmits image data together with an imaging position and an imaging date and time as image information to the deterioration diagnosis device 20. In addition, the vehicle 40 detects the acceleration of the vehicle 40 in the vertical direction by the acceleration sensor, and transmits the acceleration together with the detection position and the detection date and time as acceleration information to the deterioration diagnosis device 20. Hereinafter, information detected by a sensor mounted on the vehicle, such as image information and acceleration information, is also referred to as sensor information.

The deterioration diagnosis device 20 and the display device 30 are disposed in the above-described road management organization, for example. The deterioration diagnosis device 20 and the display device 30 may be integrated or separated. In addition, the deterioration diagnosis device 20 may be disposed in a place other than the above-described road management organization. In this case, the deterioration diagnosis device 20 may be achieved by a cloud computing system.

The deterioration diagnosis device 20 diagnoses deterioration of a road based on sensor information transmitted from each vehicle 40. Here, the deterioration diagnosis device 20 detects deterioration of the road surface such as “crack”, “rutting”, “pot hole”, and “abnormal flatness” generated on the road surface by the diagnosis. A known technique is used as a road deterioration diagnosis method based on sensor information. The deterioration diagnosis device 20 outputs the diagnosis result to a road administrator or an operator of a road management organization via the display device 30 or the terminal device 50.

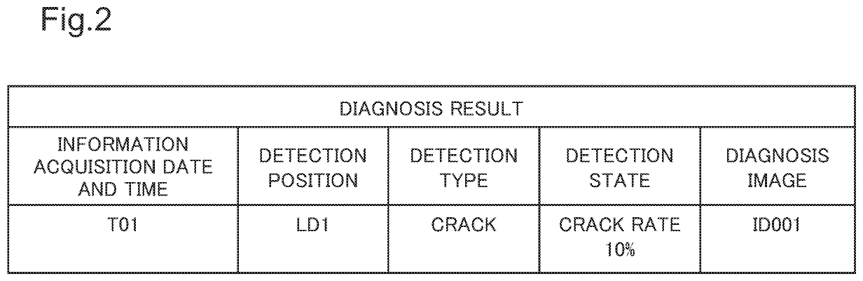

FIG. 2 is a diagram illustrating an example of a diagnosis result in the first example embodiment. As illustrated in FIG. 2, the diagnosis result includes an information acquisition date and time, a detection position, a detection type, a detection state, and a diagnosis image. Here, the information acquisition date and time indicates the acquisition date and time of the sensor information to be diagnosed (the imaging date and time of the image information and the acquisition date and time of the acceleration information). The detection position indicates a detection position of deterioration detected by the diagnosis. The detection position may be an acquisition position of the sensor information to be diagnosed (an imaging position of the image information or an acquisition position of the acceleration information).

The detection type indicates a type of deterioration detected by the diagnosis. Examples of the type of deterioration include, for example, “crack”, “rutting”, “pot hole”, “abnormal flatness”, and the like generated on the road surface. The detection state indicates a deterioration degree according to the detection type. Examples of the deterioration degree include, for example, a crack rate for the detection type “crack”, and a rut amount for the detection type “rutting”, and the like. Here, the crack rate is a value indicating a ratio between an area of deterioration included in a road image captured at a detection position (imaging position) and an area of a road included in the image. For example, an international roughness index (IRI) may be used for the detection type “abnormal flatness”. The IRI is a deterioration index indicating the flatness of the road (unevenness of the road) calculated based on the acceleration in the vertical direction included in the acceleration information acquired at the detection position. In addition, as the deterioration degree, a maintenance control index (MCI) may be used. The MCI is a composite deterioration index obtained from a crack rate, a rut amount, flatness, and the like. The diagnosis image indicates image data of image information on a road image to be diagnosed.

The terminal device 50 is carried by an operator of a road management organization or the like. The terminal device 50 is, for example, a tablet or a smartphone. The operator goes to a place where the detected deterioration occurs (hereinafter, also referred to as a site) with reference to the diagnosis result output to the terminal device 50, and directly visually confirms the deterioration. An operator who has confirmed deterioration on site transmits a deterioration confirmation result to the deterioration diagnosis device 20 using the terminal device 50.

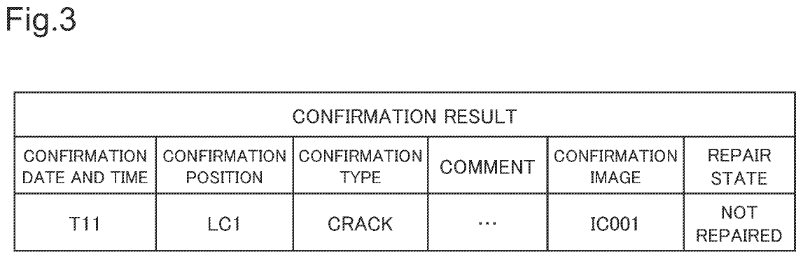

FIG. 3 is a diagram illustrating an example of a confirmation result in the first example embodiment. The confirmation result includes, for example, a confirmation date and time, a confirmation position, a confirmation type, a comment, a confirmation image, and a repair state. Here, the confirmation date and time indicates a date and time when deterioration is confirmed on site. As the confirmation date and time, for example, the imaging date and time of the confirmation image is set. Note that, as the confirmation date and time, the date and time when the confirmation result is transmitted or the date and time when the confirmation type or the comment is input by the operator may be set. The confirmation position indicates a position of deterioration confirmed on site. For example, the imaging position of the confirmation image is set as the confirmation position. Note that the position of the terminal device 50 at the time when the confirmation result is transmitted or the time when the confirmation type or the comment is input by the operator may be set as the confirmation position. The confirmation type indicates a type of deterioration confirmed on site and input by the operator. The comment is a comment about deterioration confirmed on site and input by the operator. The confirmation image is image data obtained by imaging deterioration confirmed on site. The image data of the confirmation image is designated by the operator from one or more image data captured by the operator for the deterioration when the operator goes to the site and confirms the deterioration, for example. The repair state indicates whether deterioration confirmed on site is repaired. When the deterioration is repaired, “completed” is set to the repair state. When the deterioration is not repaired, “not repaired” is set to the repair state. The repair is performed, for example, at the timing when an operator confirms deterioration on site. In addition, the repair may be performed after the timing at which the operator confirms deterioration on site. Note that the confirmation result may further include the name and identifier of the operator who has performed the confirmation, and the identifier of the terminal device 50 used for the confirmation operation.

The deterioration diagnosis device 20 stores the confirmation result received from the terminal device 50 in association with the diagnosis result.

Note that, in the present example embodiment, a case where the moving object that transmits the sensor information is the vehicle 40 will be described, but the moving object may be a bicycle, a drone, or a person as long as the sensor information can be acquired and transmitted to the deterioration diagnosis device 20.

In addition, in the present example embodiment, a case where a deterioration diagnosis target based on sensor information is deterioration of a pavement on a road (deterioration of a road surface), and the above-described type of deterioration is detected as a result of the diagnosis will be described. However, the present invention is not limited thereto, and the target of the deterioration diagnosis may be an object installed on a road such as a repair material such as a sealing material, a white line, a guardrail, a sign, a road sign, a street lamp, and the like. In this case, as a result of the diagnosis, the type of the object whose deterioration is detected is output. In addition, instead of the type of deterioration, as the above-described detection type, a type of an object whose deterioration is detected, such as a repair material, a white line, a guardrail, a sign, a road sign, or a street lamp, is used. Furthermore, the diagnosis target based on the sensor information is not limited to deterioration, and may be an obstacle such as snow accumulation on a road or a falling object. In this case, as a result of the diagnosis, the type of the detected obstacle is output. In addition, instead of the type of deterioration, as the detection type described above, the type of the detected obstacle such as snow accumulation or a falling object is used and as the detection state, the amount or size of the detected obstacle such as the amount of snow accumulation or the size of the falling object is used instead of the deterioration degree described above.

In addition, the deterioration diagnosis target may be a road on which an object other than an automobile travels, such as a runway, a taxiway, or a holding area of an airport, or a railway track.

In addition, the deterioration diagnosis target is not limited to the road as long as the deterioration diagnosis is performed based on the sensor information collected by the moving object, and may be a structure such as various buildings, facilities, and equipment installed on the ground.

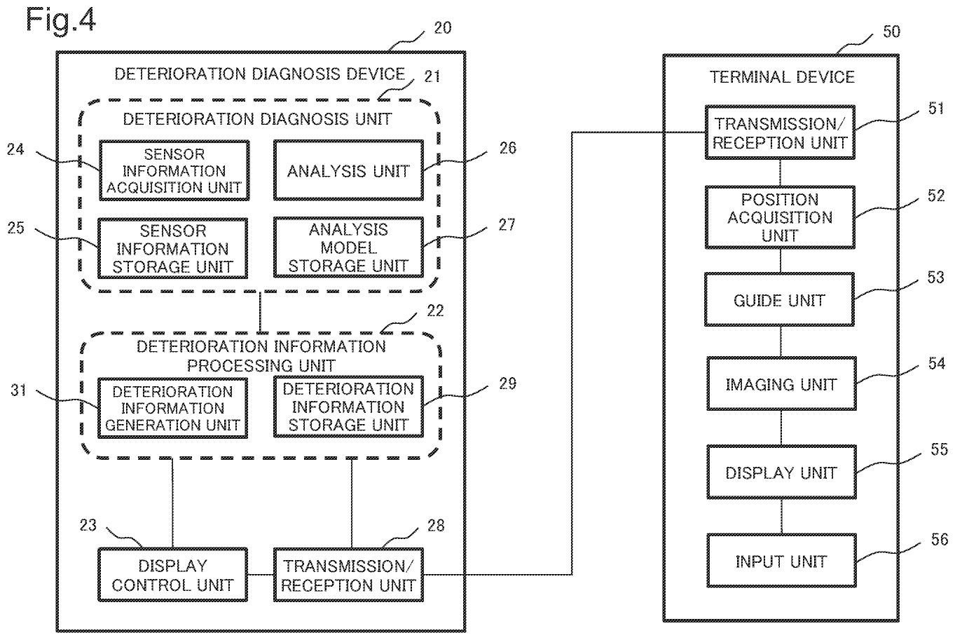

Next, configurations of the deterioration diagnosis device 20 and the terminal device 50 in the first example embodiment will be described. FIG. 4 is a block diagram illustrating a configuration of the deterioration diagnosis device 20 and the terminal device 50 in the first example embodiment.

As illustrated in FIG. 4, the deterioration diagnosis device 20 includes a deterioration diagnosis unit 21, a deterioration information processing unit 22, a display control unit 23, and a transmission/reception unit 28.

The deterioration diagnosis unit 21 includes a sensor information acquisition unit 24, a sensor information storage unit 25, an analysis unit 26, and an analysis model storage unit 27.

The sensor information acquisition unit 24 acquires sensor information from each of the vehicles 40.

The analysis unit 26 makes a deterioration diagnosis based on the acquired sensor information, that is, determination of the presence or absence and the type of deterioration by analysis of the sensor information, using a known technique. For example, the deterioration diagnosis device 20 analyzes image information using an analysis model obtained by learning an image of deterioration of a road by machine learning. Then, the analysis unit 26 calculates a deterioration degree for the detected deterioration. The analysis unit 26 outputs the diagnosis result to the deterioration information processing unit 22.

The analysis model storage unit 27 stores an analysis model used by the analysis unit 26.

The deterioration information processing unit 22 includes a deterioration information storage unit 29 and a deterioration information generation unit 31.

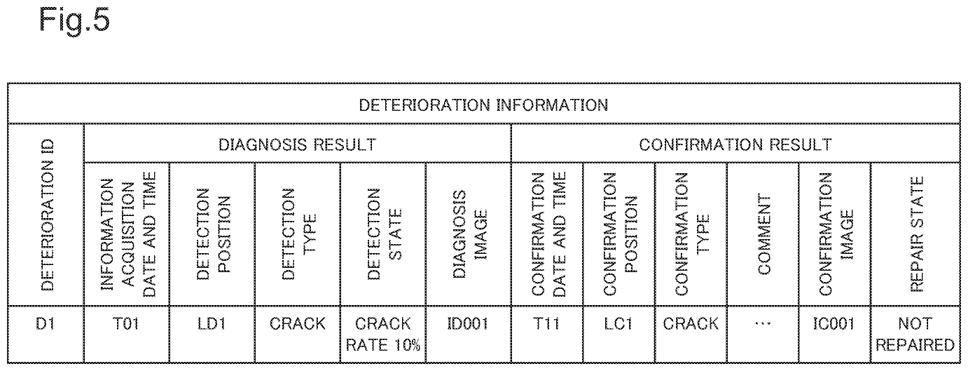

The deterioration information generation unit 31 generates deterioration information. The deterioration information is information in which the confirmation result received from the terminal device 50 is associated with the diagnosis result input from the analysis unit 26. FIG. 5 is a diagram illustrating an example of deterioration information according to the first example embodiment. As illustrated in FIG. 5, the deterioration information includes a deterioration identifier (ID), a diagnosis result, and a confirmation result. The deterioration ID is an identifier that uniquely identifies the deterioration detected by the deterioration diagnosis unit 21. The deterioration ID is assigned by the deterioration information generation unit 31. The deterioration information generation unit 31 associates (links) the diagnosis result with the confirmation result based on the detection position included in the diagnosis result and the confirmation position included in the confirmation result.

The deterioration information storage unit 29 stores the deterioration information generated by the deterioration information generation unit 31.

The display control unit 23 causes the display device 30 or the terminal device 50 to display a map screen (hereinafter, a deterioration position map screen) indicating a deterioration detection position or a screen (hereinafter, also referred to as a deterioration information screen) indicating deterioration information designated on the deterioration position map screen based on the deterioration information. The display control unit 23 displays the deterioration detection position on the deterioration position map screen in different display modes depending on the presence or absence of the confirmation result.

The transmission/reception unit 28 transmits the deterioration position map screen, the deterioration information screen, and contents of the deterioration information (for example, the deterioration detection position) in response to a request from the terminal device 50. Further, the transmission/reception unit 28 receives the confirmation result from the terminal device 50.

As illustrated in FIG. 4, the terminal device 50 includes a transmission/reception unit 51, a position acquisition unit 52, a guide unit 53, an imaging unit 54, a display unit 55, and an input unit 56.

The transmission/reception unit 51 receives the deterioration position map screen, the deterioration information screen, and the contents of the deterioration information (for example, the deterioration detection position) from the deterioration diagnosis device 20. In addition, the transmission/reception unit 51 transmits a confirmation result to the deterioration diagnosis device 20.

The position acquisition unit 52 acquires position information indicating the position of the terminal device 50. The position acquisition unit 52 acquires position information using, for example, a global positioning system (GPS).

The guide unit 53 provides route guidance to the detection position based on the position of the terminal device 50 acquired by the position acquisition unit 52 and the deterioration detection position received from the deterioration diagnosis device 20. In addition, the guide unit 53 notifies the operator that the terminal device 50 has approached the deterioration detection position.

The imaging unit 54 captures a moving image or a still image. The imaging unit captures a road image in the traveling direction at the time of route guidance. In addition, the imaging unit 54 images the confirmed deterioration according to the operation of the operator. The imaging unit 54 is, for example, a camera mounted on a tablet or a smartphone.

The display unit 55 displays the deterioration detection position received from the deterioration diagnosis device 20 on the map. In addition, the display unit 55 displays the route acquired by the guide unit 53. Further, the display unit 55 displays a confirmation result input screen by the operator. The display unit 55 is, for example, a display of a tablet or a smartphone.

The input unit 56 receives an operation instruction to the terminal device 50 and an input of a deterioration confirmation result from the operator. The input unit 56 is, for example, a touch panel provided on a display face of a tablet or a smartphone.

Note that the deterioration diagnosis unit 21, the deterioration information generation unit 31, and the deterioration information storage unit 29 are example embodiments of a diagnosis means, an association means, and a storage means of the present disclosure, respectively. Furthermore, the display control unit 23 is an example embodiment of a display control means of the present disclosure. Furthermore, each of the display device 30 and the terminal device 50 is an example embodiment of a display means of the present disclosure.

Next, an operation of the first example embodiment will be described.

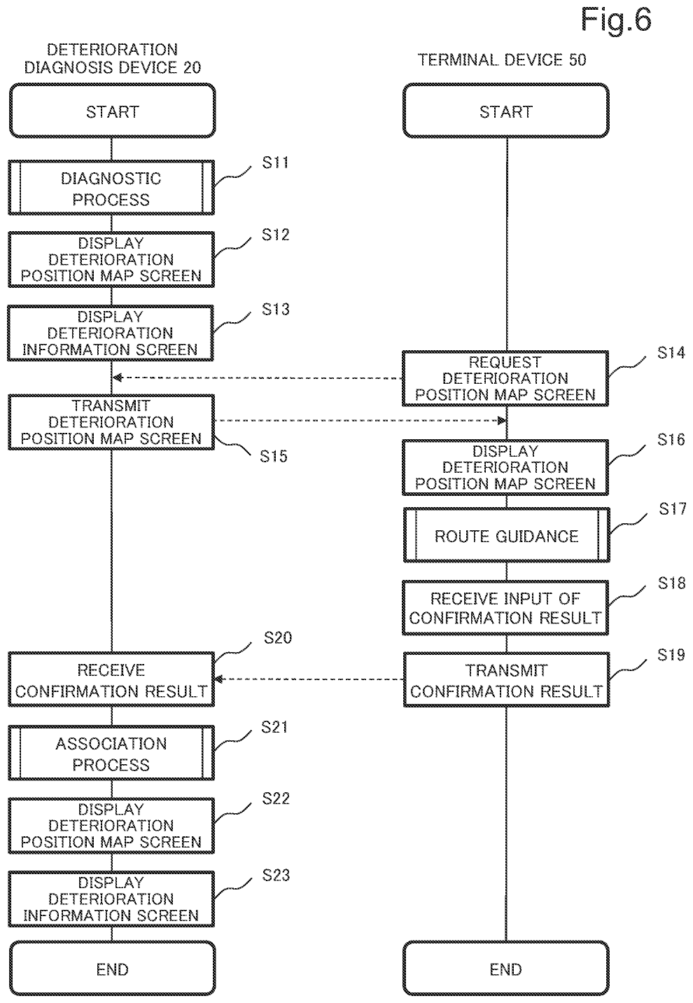

FIG. 6 is a flowchart illustrating an overall operation of the deterioration diagnosis system 10 in the first example embodiment.

The deterioration diagnosis device 20 of the deterioration diagnosis system 10 diagnoses deterioration of a road based on sensor information transmitted from each vehicle 40 and generates a diagnosis result (step S11).

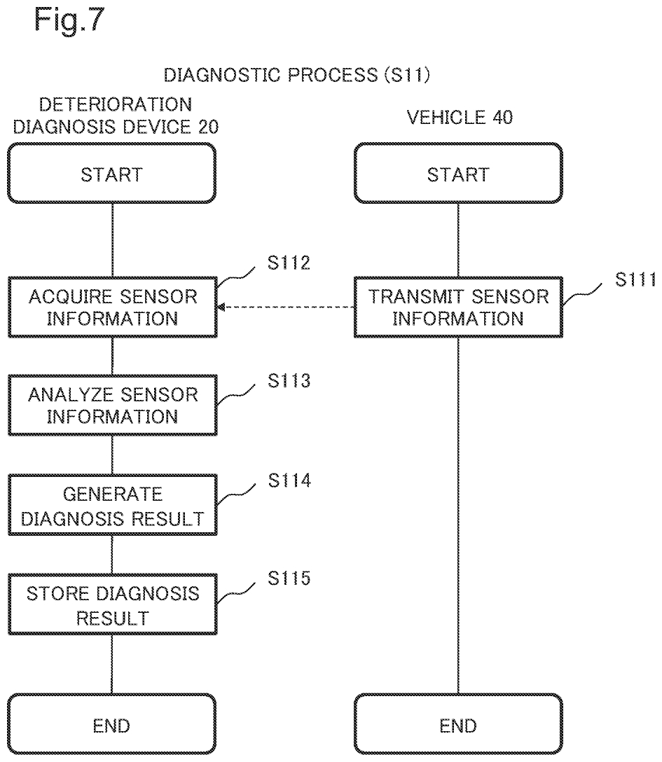

FIG. 7 is a flowchart illustrating details of the diagnosis process (step S11) in the first example embodiment.

Each vehicle 40 transmits the acquired sensor information (image information and acceleration information) to the deterioration diagnosis device 20 (step S111).

In the deterioration diagnosis device 20, the sensor information acquisition unit 24 of the deterioration diagnosis unit 21 acquires sensor information (step S112). The analysis unit 26 diagnoses deterioration of a road by analyzing the sensor information (step S113). The analysis unit 26 generates a diagnosis result for the deterioration detected by the diagnosis (step S114). For example, the analysis unit 26 generates a diagnosis result as illustrated in FIG. 2. The analysis unit 26 outputs the diagnosis result to the deterioration information processing unit 22.

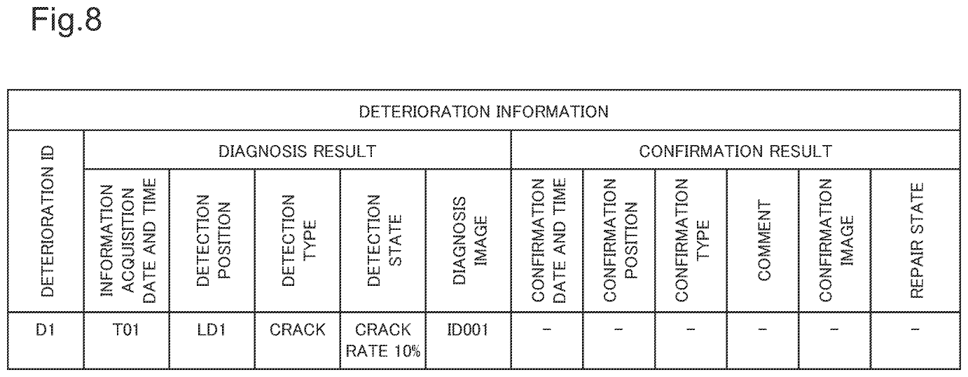

The deterioration information generation unit 31 of the deterioration information processing unit 22 stores the diagnosis result in the deterioration information and stores the diagnosis result in the deterioration information storage unit 29 (step S115). FIG. 8 is a diagram illustrating another example of the deterioration information according to the first example embodiment. For example, as shown in FIG. 8, the deterioration information generation unit 31 stores the diagnosis result of FIG. 2 for the deterioration ID “D1”.

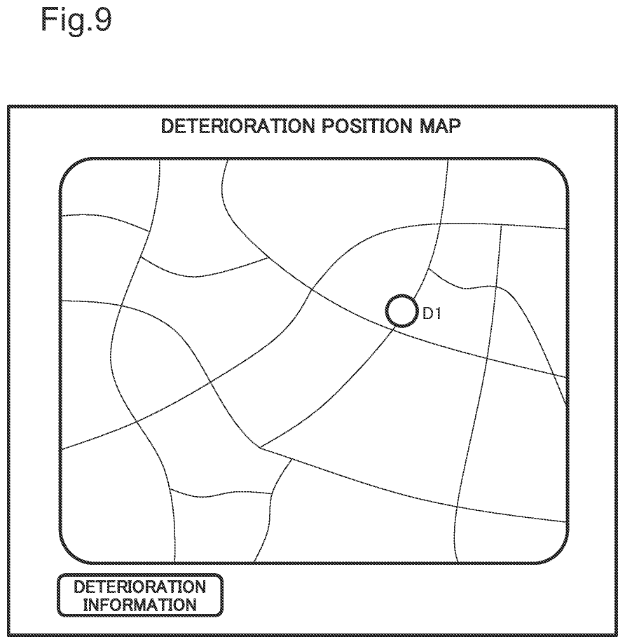

Next, the display control unit 23 displays a deterioration position map screen on the display device 30 based on the deterioration information (step S12). FIG. 9 is a diagram illustrating an example of a deterioration position map screen of the deterioration diagnosis device 20 in the first example embodiment. In the example of FIG. 9, a white circle is displayed at the detection position of the deterioration “D1” on the map, and a “deterioration information” button is further displayed. Here, the white circle indicates deterioration for which a confirmation result has not been obtained (not associated). For example, the display control unit 23 causes the display device 30 to display the deterioration position map screen of FIG. 9 based on the deterioration information of FIG. 8.

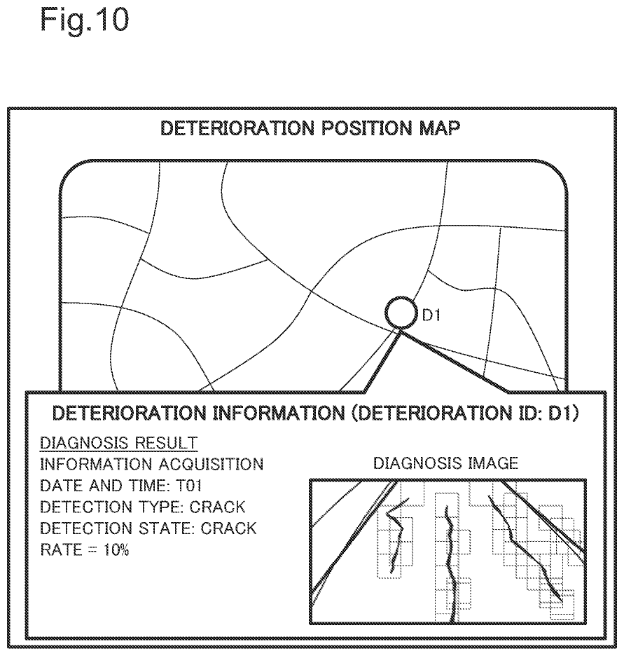

The display control unit 23 causes the display device 30 to display a deterioration information screen indicating deterioration information of deterioration designated by the road administrator on the deterioration position map screen of the display device 30 (step S13). FIG. 10 is a diagram illustrating an example of a deterioration information screen according to the first example embodiment. FIG. 10 is an example in a case where the deterioration “D1” is designated, and shows the information acquisition date and time, the detection type, the detection state, and the diagnosis image in the diagnosis result of the deterioration “D1”. For example, when the road administrator designates the deterioration “D1” on the deterioration position map screen of FIG. 9 and presses the “deterioration information” button, the display control unit 23 displays the deterioration information screen of FIG. 10 on the display device 30 based on the deterioration information of FIG. 8.

When the road administrator checks the deterioration diagnosis result on the deterioration information screen and determines that it is necessary to confirm the deterioration on site, the road administrator instructs the operator to confirm the deterioration on site. The operator carries the terminal device 50 and heads to the site.

Next, the guide unit 53 of the terminal device 50 requests the deterioration diagnosis device 20 to display the deterioration position map screen according to the operation of the operator (step S14). The display control unit 23 of the deterioration diagnosis device 20 transmits the deterioration position map screen to the terminal device 50 in response to the request from the terminal device 50 (step S15).

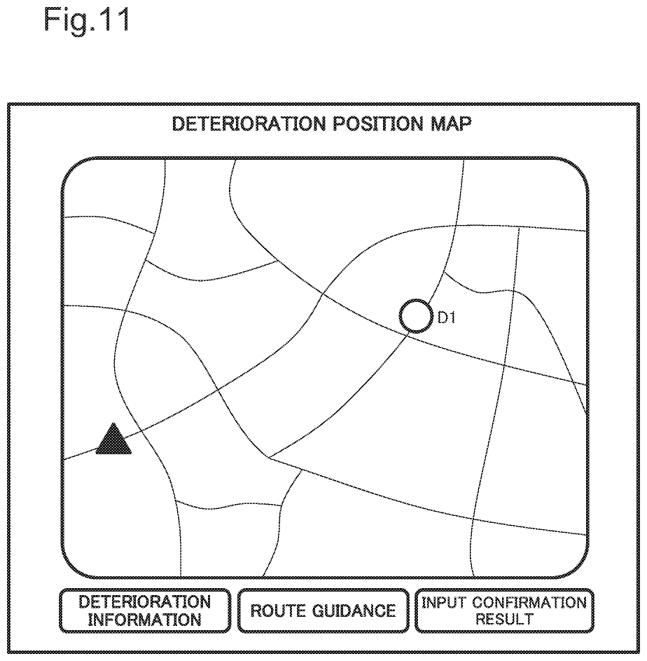

The guide unit 53 of the terminal device 50 displays the received deterioration position map screen on the display unit 55 (step S16). Here, the guide unit 53 displays the position of the terminal device 50 acquired by the position acquisition unit 52 on the deterioration position map screen. FIG. 11 is a diagram illustrating an example of a deterioration position map screen of the terminal device 50 in the first example embodiment. In the example of FIG. 11, the current position of the terminal device 50 is indicated by a black triangle on a deterioration position map screen similar to that in FIG. 9, and a “route guidance” button and an “input confirmation result” button are further displayed. For example, the guide unit 53 causes the display unit 55 to display the deterioration position map screen of FIG. 11.

As in step S13 described above, the guide unit 53 may receive designation of deterioration from the operator on the deterioration position map screen, acquire a deterioration information screen of the designated deterioration from the display control unit 23 of the deterioration diagnosis device 20, and display the deterioration information screen on the display unit 55.

Next, the guide unit 53 provides route guidance to the deterioration detection position (step S17).

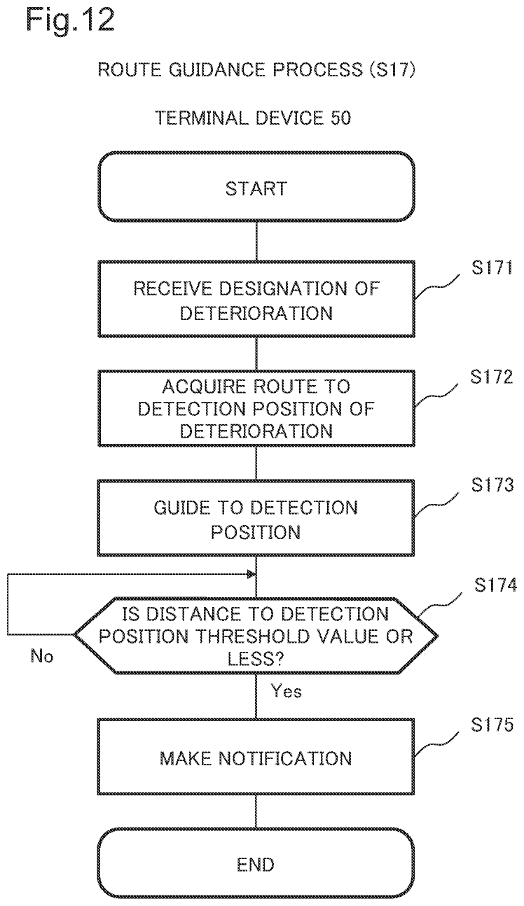

FIG. 12 is a flowchart illustrating details of the route guidance process (step S17) in the first example embodiment. The guide unit 53 receives designation of deterioration from the operator on the deterioration position map screen (step S171). The guide unit 53 acquires a route from the position of the terminal device 50 to the detection position based on the designated deterioration detection position and the position of the terminal device 50 (step S172). Here, for example, the guide unit 53 acquires the route from a server device (not illustrated) that provides a map information providing service or the like. Furthermore, the guide unit 53 may calculate a route based on map information stored in the terminal device 50. The guide unit 53 causes the display unit 55 to display a route guidance screen showing the acquired route on the deterioration position map screen.

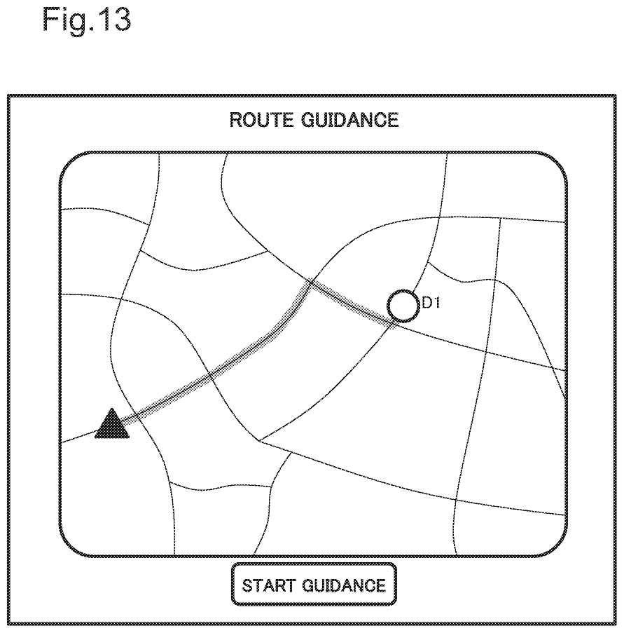

FIG. 13 is a diagram illustrating an example of a route guidance screen in the first example embodiment. In the example of FIG. 13, a route from the current position of the terminal device 50 to the detection position of the deterioration “D1” is indicated by a thick line, and a “start guidance” button is further displayed on the deterioration position map screen. For example, when the operator designates the deterioration “D1” and presses the “route guidance” button on the deterioration position map screen of FIG. 11, the guide unit 53 displays the route guidance screen of FIG. 13. Then, when the operator presses the “start guidance” button on the route guidance screen of FIG. 13, the guide unit 53 starts route guidance.

The guide unit 53 guides the operator to the detection position along the acquired route (step S173). Here, the guide unit 53 performs necessary guidance at an intersection, a branch point, or the like using, for example, a known navigation technology.

The guide unit 53 determines whether the distance between the position of the terminal device 50 and the detection position is equal to or less than a predetermined threshold value (step S174).

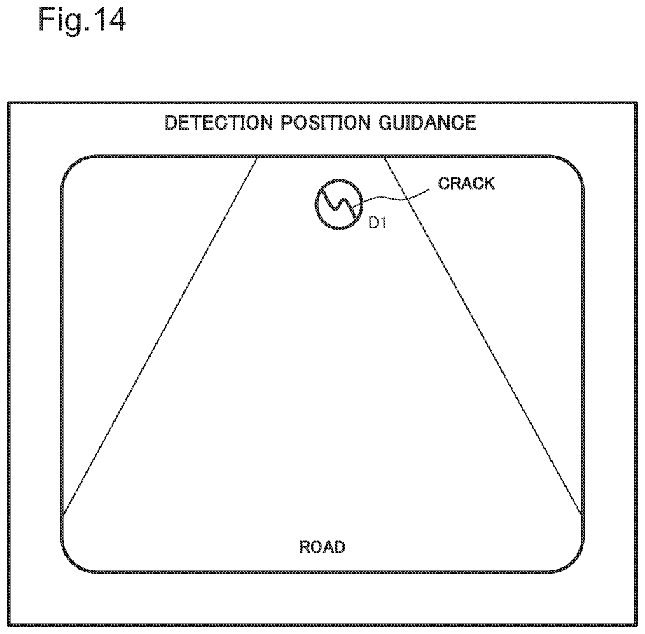

When the distance is equal to or less than the predetermined threshold value (step S174/Yes), the guide unit 53 notifies the operator that the terminal device 50 has approached the deterioration detection position (step S175). Here, for example, the guide unit 53 causes the display unit 55 to display a deterioration position guide screen indicating a deterioration detection position in the road image in the traveling direction captured by the imaging unit 54. FIG. 14 is a diagram illustrating an example of a deterioration position guide screen according to the first example embodiment. In the example of FIG. 14, a white circle indicating the deterioration “D1” and an icon indicating the detection type “crack” are superimposed at a position corresponding to the detection position “LD1” on the road image captured by the imaging unit 54. For example, the guide unit 53 displays the deterioration position guide screen of FIG. 14. The operator can easily find the deterioration corresponding to the deterioration detected by the deterioration diagnosis device 20 on site by approaching the point where the circle is superimposed and displayed while viewing the deterioration position guide screen.

The operator directly visually confirms deterioration corresponding to the deterioration detected by the deterioration diagnosis device 20. Here, the operator images the confirmed deterioration using the imaging unit 54.

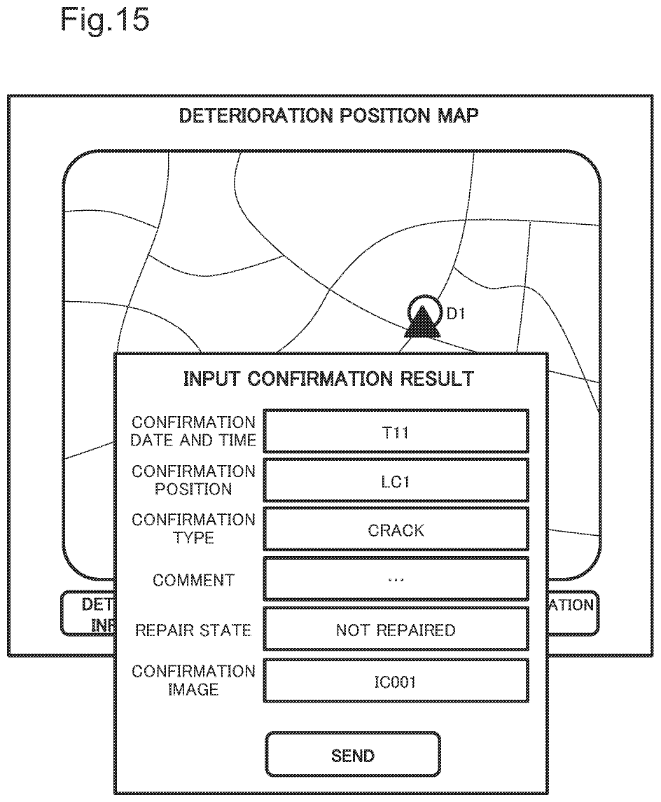

Next, the input unit 56 receives an input of a confirmation result for the confirmed deterioration from the operator (step S18). FIG. 15 is a diagram illustrating an example of a confirmation result input screen according to the first example embodiment. In the example of FIG. 15, input fields of the image data of the confirmation type, the comment, the repair state, and the confirmation image are displayed together with the confirmation date and time and the confirmation position on the deterioration position map screen, and a “send” button is further displayed. For example, when the operator presses the “input confirmation result” button on the deterioration position map screen of FIG. 11, the input unit 56 displays the confirmation result input screen of FIG. 15. Then, when the operator designates the image data of the confirmation image on the confirmation result input screen of FIG. 15, the input unit 56 displays the imaging date and time and the imaging position of the confirmation image at the confirmation date and time and the confirmation position.

The transmission/reception unit 51 transmits the confirmation result to the deterioration diagnosis device 20 (step S19). For example, when the operator presses the “send” button on the confirmation result input screen of FIG. 15, the transmission/reception unit 51 transmits the confirmation result of FIG. 3 to the deterioration diagnosis device 20.

The transmission/reception unit 28 of the deterioration diagnosis device 20 receives the confirmation result from the terminal device 50 (step S20). The deterioration information generation unit 31 of the deterioration information processing unit 22 associates the received confirmation result with the diagnosis result of the deterioration information stored in the deterioration information storage unit 29 to store the received confirmation result in the deterioration information (step S21).

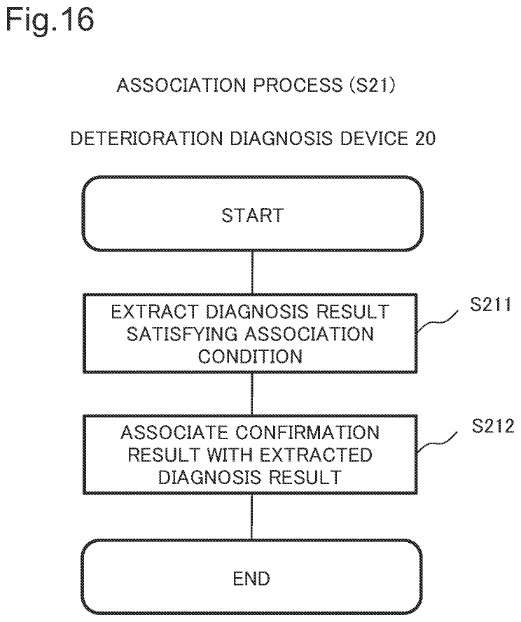

FIG. 16 is a flowchart illustrating details of the association process (step S21) according to the first example embodiment.

The deterioration information generation unit 31 of the deterioration diagnosis device 20 extracts a diagnosis result satisfying an association condition with the confirmation result received in step S20 from among diagnosis results with which no confirmation result is associated in the deterioration information (step S211). Here, as the association condition, for example, that the distance between the detection position in the diagnosis result and the confirmation position in the confirmation result is equal to or less than a predetermined threshold value (hereinafter, also referred to as a condition 1) is used.

In addition to the condition 1, a time difference between the information acquisition date and time in the diagnosis result and the confirmation date and time in the confirmation result is equal to or less than a predetermined threshold value (hereinafter, also referred to as a condition 2), that is, an AND condition of the condition 1 and the condition 2 may be used as the association condition.

In addition to the condition 1, that the detection type of the diagnosis result and the confirmation type of the confirmation result are the same type (hereinafter, also referred to as a condition 3), that is, an AND condition of the condition 1 and the condition 3 may be used as the association condition.

Further, an AND condition of the conditions 1, 2, and 3 may be used as the association condition.

The deterioration information generation unit 31 stores the extracted diagnosis result in association with the confirmation result in the deterioration information and stores it in the deterioration information storage unit 29 (step S212).

For example, as the association condition, in a case where the above-described condition 1 is used and in a case where the distance between the confirmation position “LC1” of the confirmation result in FIG. 3 and the detection position “LD1” of the diagnosis result of the deterioration “D1” in the deterioration information in FIG. 8 is equal to or less than a predetermined threshold value, the deterioration information generation unit 31 extracts the diagnosis result of the deterioration “D1”. Then, as shown in FIG. 5, the deterioration information generation unit 31 associates the confirmation result of FIG. 3 with the diagnosis result of the deterioration “D1”.

In step S211, when the diagnosis result satisfying the association condition with the confirmation result cannot be extracted, the deterioration information generation unit 31 may store the confirmation result received in step S20 as new deterioration in the deterioration information. In this case, for example, the deterioration information generation unit 31 assigns a new deterioration ID to the confirmation result and stores it in the deterioration information.

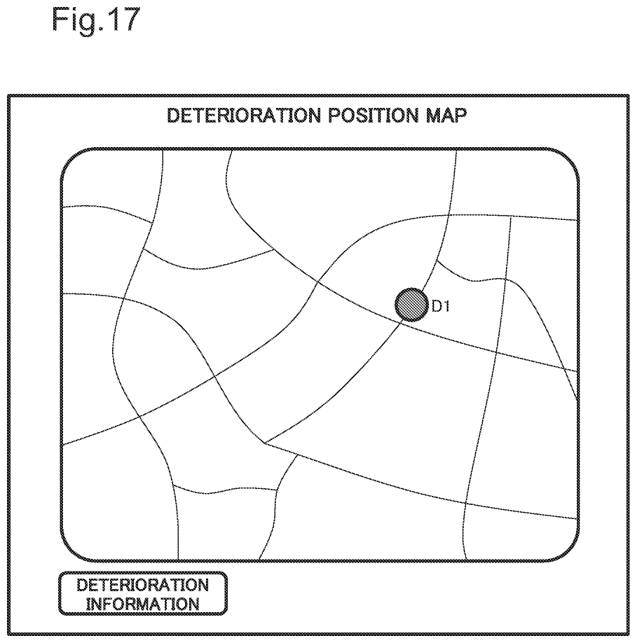

Next, the display control unit 23 causes the display device 30 to display a deterioration position map screen based on the updated deterioration information (step S22). FIG. 17 is a diagram illustrating another example of the deterioration position map screen of the deterioration diagnosis device 20 in the first example embodiment. In the example of FIG. 17, a gray circle is displayed at the detection position of the deterioration “D1” on the map. Here, a gray circle indicates deterioration for which a confirmation result has been obtained (associated). For example, the display control unit 23 causes the display control unit 23 to display the deterioration position map screen of FIG. 17 based on the deterioration information of FIG. 5.

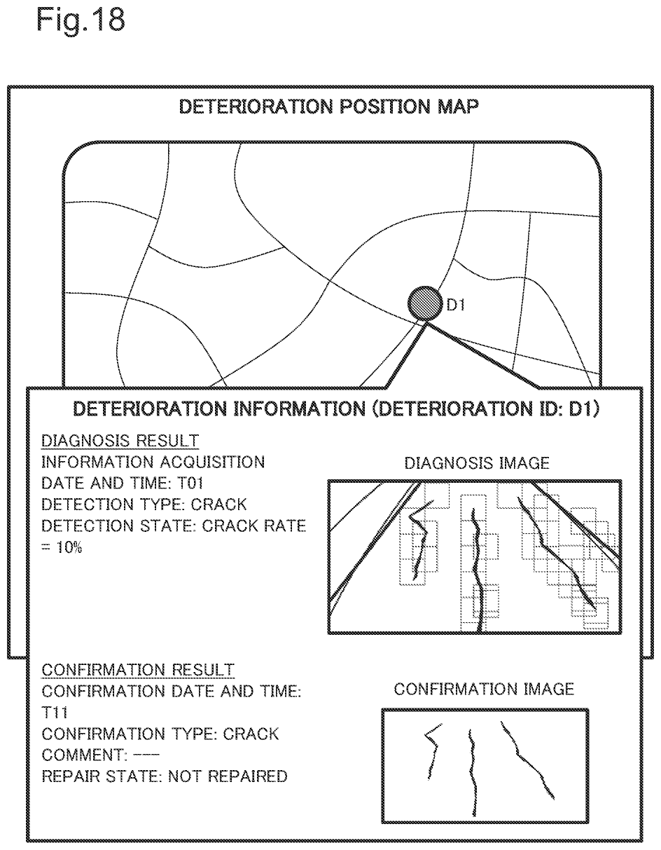

The display control unit 23 causes the display device 30 to display a deterioration information screen indicating deterioration designated by the road administrator on the deterioration position map screen of the display device 30 (step S23). FIG. 18 is a diagram illustrating another example of the deterioration information screen according to the first example embodiment. FIG. 18 illustrates an example of a case where the deterioration “D1” is designated, and illustrates the confirmation date and time, the confirmation type, the comment, the repair state, and the confirmation image in the confirmation result in addition to the information acquisition date and time, the detection type, the detection state, and the diagnosis image in the diagnosis result of the deterioration “D1”. For example, when the road administrator designates deterioration “D1” on the deterioration position map screen of FIG. 17 and presses the “deterioration information” button, the display control unit 23 displays the deterioration information screen of FIG. 18 on the display device 30 based on the deterioration information of FIG. 5.

Further, as in steps S14 to S16 described above, the terminal device 50 may receive and display the deterioration position map screen and the deterioration information screen based on the updated deterioration information from the deterioration diagnosis device 20.

Thereafter, when new sensor information is transmitted from the vehicle 40 to the deterioration diagnosis device 20, the operation from step S11 is executed.

For example, in a case where deterioration of the detection type same as the detected deterioration is detected in the vicinity of the detected deterioration detection position by the diagnosis on the new sensor information, the deterioration information generation unit 31 determines that the deterioration due to the new diagnosis is a deterioration same as the detected deterioration. Here, the vicinity means that the distance is within a predetermined range. In this case, the deterioration information generation unit 31 updates the diagnosis result of the detected deterioration with a new diagnosis result in the deterioration information.

On the other hand, when deterioration of a detection type different from the detected deterioration is detected in the vicinity of the detected deterioration detection position by the diagnosis on the new sensor information, the deterioration information generation unit 31 determines that the deterioration due to the new diagnosis is a new deterioration. In this case, the deterioration information generation unit 31 registers the new diagnosis result as a new deterioration diagnosis result in the deterioration information.

Thus, the operation of the first example embodiment is completed.

(First Modification of First Example Embodiment)

In the above description, in the deterioration position map, the deterioration with which the confirmation result is not associated and the deterioration with which the confirmation result is associated in the deterioration information are displayed in different modes (white circle and gray circle). The present invention is not limited thereto, and the deterioration may be displayed in another mode according to the content of the deterioration information. In this case, depending on the content of the deterioration information deterioration may be displayed using, for example, different symbols, figures, characters, patterns, colors, sizes, line types, and combinations thereof.

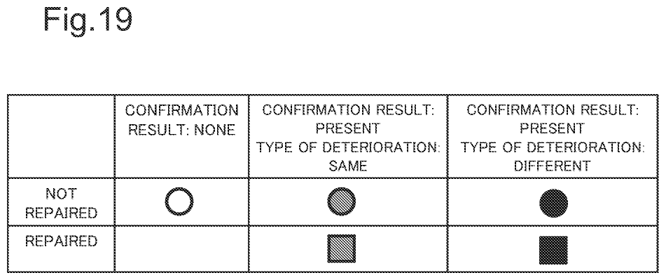

FIG. 19 is a diagram illustrating a definition example of a display mode of deterioration on the deterioration position map screen in the first example embodiment. In the example of FIG. 19, different figures are defined according to the presence or absence of association of the confirmation result in the deterioration information (confirmation result: presence or absence), the sameness or difference between the detection type of the diagnosis result and the confirmation type of the confirmation result (type: same or different), and the presence or absence of repair (repair: completed or not repaired) indicated by the repair state of the confirmation result.

For each deterioration included in the deterioration information, the display control unit 23 determines a display mode (figure) of the deterioration according to the content of the deterioration information, and displays the display mode at a position where the deterioration is detected on the map.

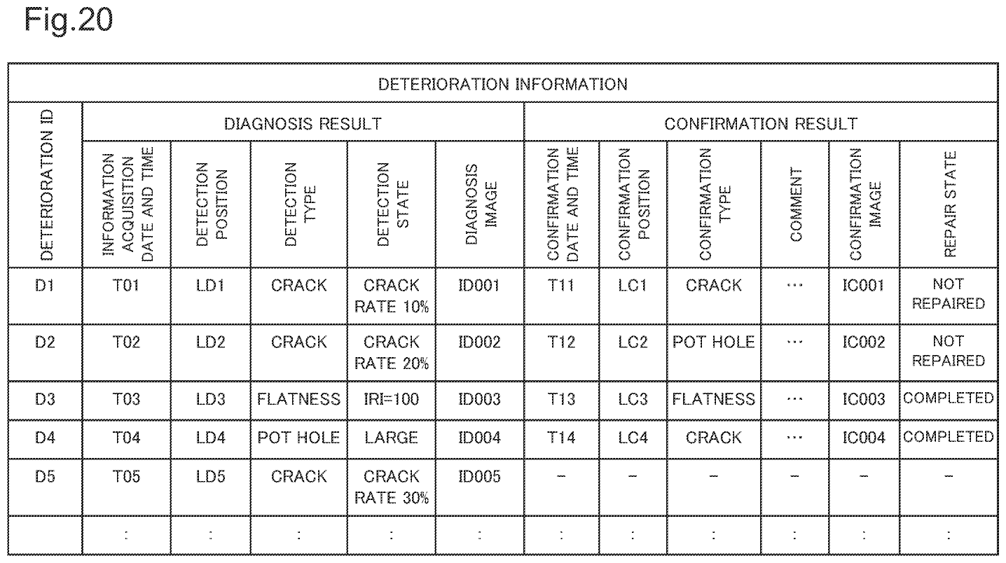

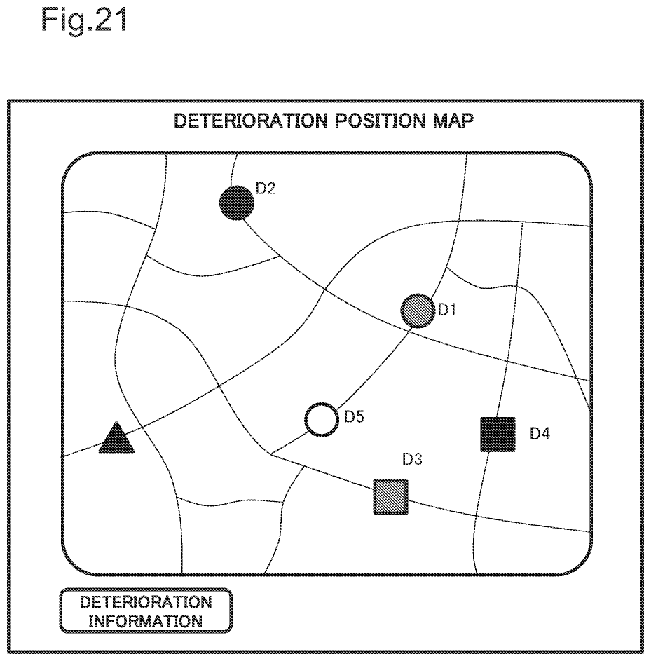

FIG. 20 is a diagram illustrating still another example of the deterioration information according to the first example embodiment. FIG. 21 is a diagram showing still another example of the deterioration position map screen in the first example embodiment. For example, the display control unit 23 causes the display device 30 to display the deterioration position map screen of FIG. 20 based on the definition of the display mode of FIG. 19 and the deterioration information of FIG. 21.

(Second Modification of First Example Embodiment)

When deterioration of the detection type same as the deterioration is detected in the vicinity of the detected deterioration detection position by the diagnosis on the new sensor information, the deterioration information generation unit 31 may determine whether the detection state (deterioration degree) is deteriorated. Here, when the detection state in the new diagnosis result is worse than that in the previous diagnosis result, the deterioration information generation unit 31 may delete the associated confirmation result and notify the road administrator of the deterioration of the detection state. For example, when a difference between a detection state in a new diagnosis result and a detection state in a previous diagnosis result is a predetermined threshold value or more, the deterioration information generation unit 31 determines that the detection state is deteriorated.

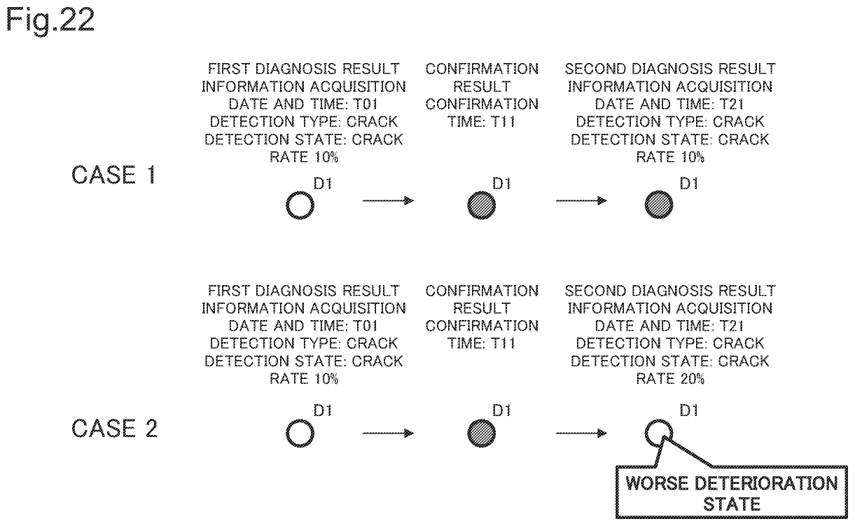

FIG. 22 is a diagram illustrating an example of transition of a display mode of deterioration in the first example embodiment. In the example of FIG. 22, a previous diagnosis result at the detection position “LD1” of the deterioration “D1” is described as a first diagnosis result, and a new diagnosis result in the vicinity of the detection position “LD1” is described as a second diagnosis result. In addition, the display mode of deterioration in FIG. 22 follows the definition of FIG. 19.

For example, when the predetermined threshold value related to the detection state “crack rate” is “5%”, in Case 1 of FIG. 22, the difference between the detection states is less than the predetermined threshold value, and thus the confirmation result is not deleted. Therefore, the “gray circle” displayed when the confirmation result is obtained for the first diagnosis result does not change even when the second diagnosis result is obtained. On the other hand, in Case 2 of FIG. 22, since the difference between the detection states is equal to or larger than the predetermined threshold value, the confirmation result is deleted. Therefore, the display mode “gray circle” displayed when the confirmation result is obtained for the first diagnosis result is returned to “white circle” when the second diagnosis result is obtained. Then, the deterioration of the detection state is notified by the pop-up.

As a result, the road administrator can grasp that the detection state has deteriorated with respect to the confirmed deterioration. Then, the necessity of on-site reconfirmation can be determined, and the operator can be instructed to perform on-site reconfirmation.

(Third Modification of First Example Embodiment)

When deterioration of the detection type same as the deterioration is detected in the vicinity of the detection position of the detected and repaired deterioration by the diagnosis on new sensor information, there is a possibility that a repair trace is erroneously detected as deterioration. Therefore, in this case, the deterioration information generation unit 31 may notify a maintenance person or the like of the deterioration diagnosis device 20 of a new diagnosis result to check whether it is erroneous detection. As a result of confirmation by the maintenance person or the like, in the case of erroneous detection, the deterioration information generation unit 31 does not update the diagnosis result in the deterioration information. On the other hand, when it is not erroneous detection, the deterioration information generation unit 31 may register the new diagnosis result as a new deterioration diagnosis result in the deterioration information and notify the road administrator of detection of the new deterioration. As described above, when the deterioration information generation unit 31 notifies the maintenance person of the new diagnosis result in the vicinity of the detection position of the detected and repaired deterioration, the maintenance person can check data that causes erroneous detection, and can use it for improving the accuracy of the diagnosis result of the deterioration diagnosis device 20. Note that confirmation of erroneous detection may be performed by a person other than the maintenance person, such as a road administrator.

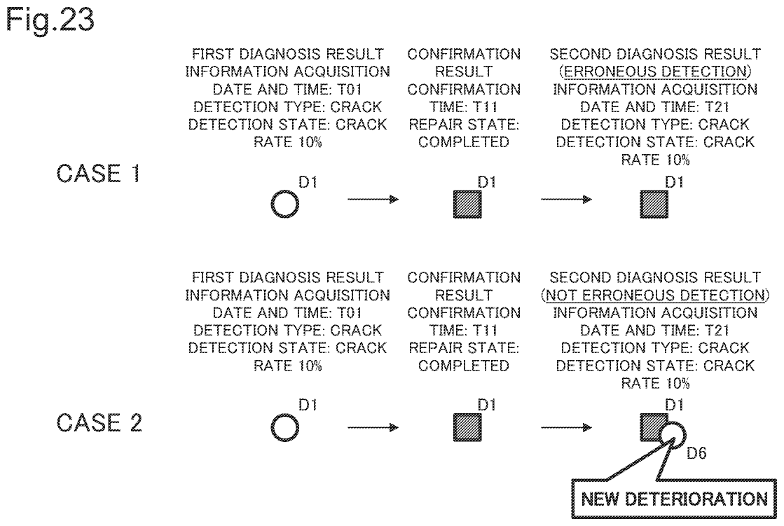

FIG. 23 is a diagram illustrating another example of transition of the display mode of deterioration according to the first example embodiment. In the example of FIG. 23, a previous diagnosis result at the detection position “LD1” of the repaired deterioration “D1” is described as a first diagnosis result, and a new diagnosis result in the vicinity of the detection position “LD1” is described as a second diagnosis result. The deterioration display mode in FIG. 23 is in accordance with the definition in FIG. 19.

For example, in Case 1 of FIG. 23, since the confirmation result by the maintenance person or the like is erroneous detection, the diagnosis result is not updated. Therefore, the “gray square” displayed when the confirmation result is obtained for the first diagnosis result does not change even when the second diagnosis result is obtained. On the other hand, in Case 2 of FIG. 23, since the confirmation result by the maintenance person or the like is not erroneous detection, the second diagnosis result is registered as a new diagnosis result of the deterioration “D6”. Therefore, the “white circle” is further displayed for the second diagnosis result. Then, detection of new deterioration is notified by a pop-up.

As a result, the road administrator can grasp that new deterioration has occurred near the repaired deterioration. Then, the necessity of on-site confirmation can be determined, and the operator can be instructed to perform on-site confirmation.

(Fourth Modification of First Example Embodiment)

In the first example embodiment, a condition related to a date and time and a type of deterioration in addition to a position is used as an association condition between a diagnosis result and a confirmation result. However, the present invention is not limited thereto, and a condition regarding the imaging direction may be further used.

For example, the deterioration diagnosis device 20 acquires sensor information including the imaging direction of the road image from the vehicle 40, includes the sensor information in the diagnosis result, and stores the sensor information in the deterioration information. The imaging direction of the road image is acquired by, for example, a gyro sensor mounted on the vehicle. In addition, the deterioration diagnosis device 20 acquires the confirmation result including the imaging direction of the confirmation image from the terminal device 50. The imaging direction of the confirmation image is also acquired by, for example, the gyro sensor of the terminal device 50.

The deterioration information generation unit 31 sets the fact that the difference between the imaging direction of the diagnosis result and the imaging direction of the confirmation result is equal to or less than a predetermined threshold value in the above-described association process for a condition 4 (step S21). Then, the deterioration information generation unit 31 associates the diagnosis result with the confirmation result using an AND condition of the condition 1 and the condition 4, an AND condition of the conditions 1, 2, and 4, an AND condition of the conditions 1, 3, and 4, or an AND condition of the conditions 1, 2, 3, and 4 as the association conditions.

As a result, the diagnosis result and the confirmation result can be more accurately associated with each other.

(Fifth Modification of First Example Embodiment)

In the first example embodiment, the case where the confirmation result is associated with the diagnosis result stored in the deterioration information is described. However, the present invention is not limited thereto, and the diagnosis result may be associated with the confirmation result stored in the deterioration information.

For example, there is a case where deterioration of a road is reported as a complaint from a local resident, and an operator goes to a complained deterioration point to transmit a confirmation result of the deterioration to the deterioration diagnosis device 20. In this case, the road administrator receives a complaint related to deterioration of a road at a certain point from a local resident. The deterioration complaint is received, for example, at a counter, a telephone, an e-mail, or the like. The road administrator notifies the operator of information such as the position of deterioration and the type and size of deterioration in the received complaint. The operator goes to the site based on such information, confirms the complained deterioration to transmit a confirmation result to the deterioration diagnosis device 20 using the terminal device 50.

In the deterioration diagnosis device 20, the deterioration information generation unit 31 determines whether there is a diagnosis result that satisfies an association condition with the received confirmation result. When there is a diagnosis result that satisfies the association condition, the deterioration information generation unit 31 associates the confirmation result with the diagnosis result.

When there is no diagnosis result satisfying the association condition, the deterioration information generation unit 31 stores the confirmation result as new deterioration in the deterioration information. In this case, for example, the deterioration information generation unit 31 assigns a new deterioration ID to the confirmation result and stores it in the deterioration information. In addition, as described above, the display control unit 23 may indicate the deterioration with which the diagnosis result is not associated in the deterioration information at a confirmation position on the deterioration position map. In this case, the display control unit 23 may indicate the deterioration with which the diagnosis result is not associated different, in a mode, from that of the deterioration for which the diagnosis result is obtained.

Thereafter, when a new diagnosis result is acquired by the deterioration diagnosis unit 21, the deterioration information generation unit 31 determines the presence or absence of a confirmation result that satisfies an association condition with the new diagnosis result among confirmation results with which no diagnosis result is associated in the deterioration information. When there is a confirmation result that satisfies the association condition, the deterioration information generation unit 31 associates the diagnosis result with the confirmation result. As described above, the display control unit 23 may indicate the deterioration associated with the diagnosis result at a detection position on the deterioration position map in the same mode as the deterioration for which the confirmation result is obtained, for example, as illustrated in FIG. 17.

As a result, even when a confirmation result is obtained before a diagnosis result for certain deterioration, the diagnosis result and the confirmation result can be associated with each other.

(Effects of First Example Embodiment)

According to the first example embodiment, it is possible to associate a correct confirmation result at an occurrence place with deterioration detected based on sensor information collected by a moving object. The reason is that the deterioration information processing unit 22 of the deterioration diagnosis device 20 associates the diagnosis result with the confirmation result based on the position of deterioration on the road confirmed by the operator and the position of deterioration detected by the diagnosis.

(Second Example Embodiment)

The second example embodiment will be described.

In the second example embodiment, a case where there is a plurality of diagnosis results satisfying an association condition with a confirmation result in the association process will be described.

In the above-described association process (step S21), when there is a plurality of diagnosis results satisfying the association condition with the confirmation result, the deterioration information generation unit 31 outputs the diagnosis results satisfying the association condition to the road administrator as association candidates. Then, the deterioration information generation unit 31 receives, from the road administrator, selection of a diagnosis result to be associated with the confirmation result among the association candidates.

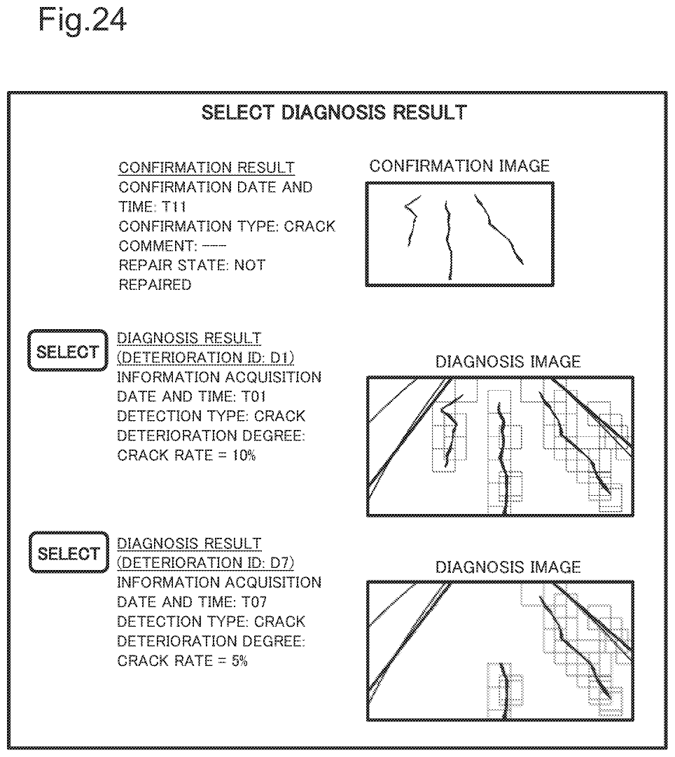

FIG. 24 is a diagram illustrating an example of a diagnosis result selection screen according to the second example embodiment. In the example of FIG. 24, a confirmation result, the diagnosis results of the deterioration “D1” and “D7” satisfying the association condition with the confirmation result, and the “select” button for each diagnosis result are displayed.

The road administrator selects a diagnosis result associated with the confirmation target by comparing each diagnosis image with the confirmation image, for example.

For example, the deterioration information generation unit 31 causes the display control unit 23 to display the diagnosis result selection screen of FIG. 24 on the display device 30, associates the confirmation result with the diagnosis result selected by the road administrator pressing the “select” button, and stores the diagnosis result in the deterioration information.

(Effects of Second Example Embodiment)

According to the second example embodiment, in addition to the effects of the first example embodiment, it is possible to associate a correct confirmation result even in a case where there is a plurality of diagnosis results satisfying the association condition with the confirmation result. The reason is that, in a case where there is a plurality of diagnosis results satisfying the association condition, the deterioration information processing unit 22 outputs the plurality of diagnosis results and receives selection of a diagnosis result to be associated with a confirmation result among the plurality of diagnosis results.

(Third Example Embodiment)

The third example embodiment will be described.

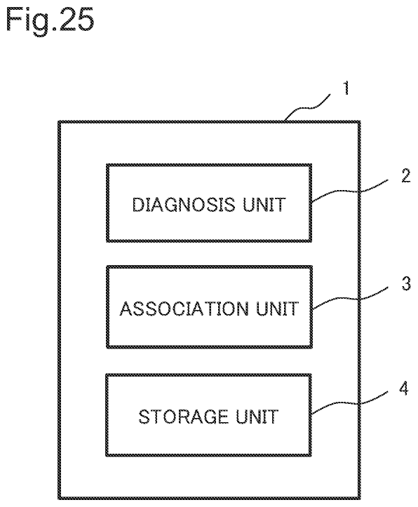

FIG. 25 is a block diagram illustrating a configuration of a deterioration diagnosis device 1 according to the third example embodiment. The deterioration diagnosis device 1 includes a diagnosis unit 2, an association unit 3, and a storage unit 4. The diagnosis unit 2, the association unit 3, and the storage unit 4 are example embodiments of a diagnosis means, an association means, and a storage means of the present disclosure, respectively. The diagnosis unit 2, the association unit 3, and the storage unit 4 correspond to the deterioration diagnosis unit 21, the deterioration information generation unit 31, and the deterioration information storage unit 29 of the first example embodiment, respectively.

The diagnosis unit 2 diagnoses deterioration on a road by analyzing sensor information collected by a moving object to output a position of a detected deterioration. The association unit 3 associates the result of the diagnosis with the result of the confirmation based on the position of deterioration of the road surface confirmed by the person and the position of deterioration detected by the diagnosis. A storage unit 4 stores therein the diagnosis result and the confirmation result thus associated.

(Effects of Third Example Embodiment)

According to the third example embodiment, it is possible to associate a correct confirmation result at an occurrence place with deterioration detected based on sensor information collected by a moving object. The reason is that the association unit 3 of the deterioration diagnosis device 1 associates the result of the diagnosis with the result of the confirmation based on the position of deterioration on the road confirmed by the person and the position of deterioration detected by the diagnosis.

(Hardware Configuration)

In each of the example embodiments described above, each component of the deterioration diagnosis device 20 and the terminal device 50 represents a functional unit block. A part or all of each component of each device may be achieved by an any combination of a computer 500 and a program.

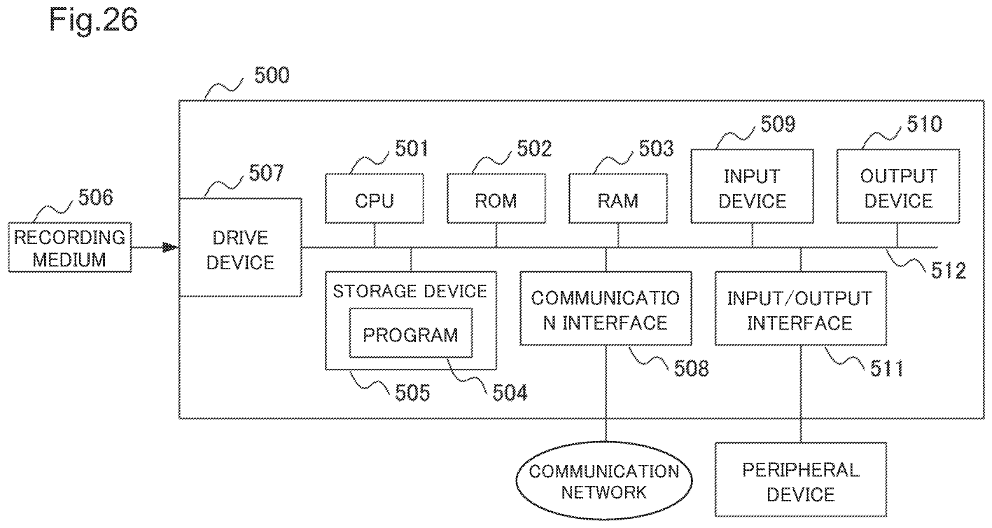

FIG. 26 is a block diagram illustrating an example of a hardware configuration of the computer 500. Referring to FIG. 26, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes an instruction for achieving each function of each of devices. The program 504 is stored in advance in the ROM 502, the RAM 503, and the storage device 505. The CPU 501 achieves each function of each of devices by executing instructions included in the program 504. For example, the CPU 501 of the deterioration diagnosis device 20 executes instructions included in the program 504 to implement the functions of the display control unit 23, the sensor information acquisition unit 24, the analysis unit 26, the transmission/reception unit 28, and the deterioration information generation unit 31. Further, for example, the RAM 503 of the deterioration diagnosis device 20 may store the data of the analysis model storage unit 27. In addition, for example, the storage device 505 of the deterioration diagnosis device 20 may store the data of the sensor information storage unit 25 and the deterioration information storage unit 29.

The drive device 507 reads and writes the recording medium 506. The communication interface 508 provides an interface with a communication network. The input device 509 is, for example, a mouse, a keyboard, or the like, and receives an input of information from an operator or the like. The output device 510 is, for example, a display, and outputs (displays) information to an operator or the like. The input/output interface 511 provides an interface with a peripheral device. The bus 512 connects the respective components of the hardware. Note that the program 504 may be supplied to the CPU 501 via a communication network, or may be stored in the recording medium 506 in advance, read by the drive device 507, and supplied to the CPU 501.

Note that the hardware configuration illustrated in FIG. 26 is an example, and other components may be added or some components may not be included.

There are various modifications in the method of achieving the deterioration diagnosis device 20 and the terminal device 50. For example, the deterioration diagnosis device 20 may be achieved by an any combination of a computer and a program different for each component. In addition, a plurality of components included in each device may be achieved by an any combination of one computer and a program.

In addition, some or all of the components of each device may be achieved by general-purpose or dedicated circuitry including a processor or the like, or a combination thereof. The circuitry may be configured by a single chip or may be configured by a plurality of chips connected via a bus. Part or all of each component of each of devices may be achieved by a combination of the above-described circuitry or the like and a program.

In addition, in a case where part or all of each component of each of devices is achieved by a plurality of computers, circuits, and the like, the plurality of computers, circuits, and the like may be disposed in a centralized manner or in a distributed manner.

While the present disclosure has been particularly shown and described with reference to example embodiments thereof, the present disclosure is not limited to these example embodiments. Various modifications that can be understood by those skilled in the art can be made to the configuration and details of the present disclosure within the scope of the present disclosure. In addition, the configurations in the respective example embodiments can be combined with each other without departing from the scope of the present disclosure.

### REFERENCE SIGNS LIST

1, 20 deterioration diagnosis device
2 diagnosis unit
3 association unit
4 storage unit
10 deterioration diagnosis system
21 deterioration diagnosis unit
22 deterioration information processing unit
23 display control unit
24 sensor information acquisition unit
25 sensor information storage unit
26 analysis unit
27 analysis model storage unit
28, 51 transmission/reception unit
29 deterioration information storage unit
30 display device
31 deterioration information generation unit
40 vehicle
50 terminal device
52 position acquisition unit
53 guide unit
54 imaging unit
55 display unit
56 input unit
500 computer
501 CPU
502 ROM
503 RAM
504 program
505 storage device
506 recording medium
507 drive device
508 communication interface
509 input device
510 output device
511 input/output interface
512 bus

What is claimed is:

1. A deterioration diagnosis device comprising:
a memory storing instruction; and
one or more processors configured to execute the instructions to:
diagnose deterioration on a road by analyzing sensor information collected by a moving object;
output a position of a detected deterioration;
associate, based on a position of deterioration on a road confirmed by a person and a position of deterioration detected by the diagnosis, a result of the diagnosis with a result of the confirmation; and
store the result of the diagnosis and the result of the confirmation associated with each other.

2. The deterioration diagnosis device according to claim 1, wherein
the one or more processors are further configured to execute the instructions to:
associate the result of the diagnosis with the result of the confirmation based on an association condition including a condition related to a distance between the position of the detected deterioration and the position of the confirmed deterioration, and one or more of a condition related to a time difference between a date and time when the sensor information is collected and a date and time when the confirmation is made and a condition related to a type of the detected deterioration and a type of the confirmed deterioration.

3. The deterioration diagnosis device according to claim 2, wherein
the one or more processors are further configured to execute the instructions to:
in a case where there is a plurality of results of the diagnosis satisfying the association condition, output the plurality of results of the diagnosis; and
receive selection of a result of the diagnosis associated with a result of the confirmation from among the plurality of results of the diagnosis.

4. The deterioration diagnosis device according to claim 1, wherein the one or more processors are further configured to execute the instructions to:
cause a display means to display a result of the diagnosis associated with a result of the confirmation different, in a mode, from a result of the diagnosis not associated with the result of the confirmation.

5. A deterioration diagnosis system comprising:
the deterioration diagnosis device according to claim 1; and
a terminal device including
a memory storing instruction; and
one or more processors configured to execute the instructions to:
receive an input of a result of the confirmation to transmit the result of the confirmation to the deterioration diagnosis device.

6. The deterioration diagnosis system according to claim 5, wherein
the one or more processors in the terminal device are further configured to execute the instructions to:
output a route from a position of the terminal device to the position of the detected deterioration to a user of the terminal device.

7. The deterioration diagnosis system according to claim 5, wherein
the one or more processors in the terminal device are further configured to execute the instructions to:
make a notification to a user of the terminal device when a distance between a position of the terminal device and the position of the detected deterioration is equal to or less than a predetermined threshold value.

8. A deterioration diagnosis method comprising:
diagnosing deterioration on a road by analyzing sensor information collected by a moving object;
outputting a position of a detected deterioration;
associating, based on a position of deterioration on a road confirmed by a person and a position of deterioration detected by the diagnosis, a result of the diagnosis with a result of the confirmation; and
storing the result of the diagnosis and the result of the confirmation associated with each other.

9. (canceled)
